(19) United States
(12) Patent Application Publication
(10) Pub. No.: US 2022/0205793 A1
(43) Pub. Date: Jun. 30, 2022

(54) Vehicle and a Method of Controlling the Same

(71) Applicants: Hyundai Motor Company, Seoul (KR); Kia Corporation, Seoul (KR)

(72) Inventors: Kyungjin You, Anyang (KR); Nahyeon Pak, Anyang (KR)

(21) Appl. No.: 17/499,164

(22) Filed: Oct. 12, 2021

(30) Foreign Application Priority Data
Dec. 29, 2020 (KR) 10-2020-0185587

(51) Int. Cl. G01C 21/34; G01C 21/36

(52) U.S. Cl. CPC G01C 21/3415; G01C 21/3492; G01C 21/3694; G01C 21/3617; G01C 21/3685; G01C 21/3484

(57) ABSTRACT

A vehicle includes: a communication device configured to obtain traffic information from a server; an input device configured to receive departure information and destination information from a user; a display device; a storage configured to store driving record information; and a controller configured to obtain movement route information by searching for at least one movement route based on the departure information and the destination information, calculate a congestion level of the movement route based on the movement route information and the traffic information, if the congestion level is less than a predetermined reference value, determine a first urgency level in response to a destination based on at least one of the driving record information or the destination information, determine a final movement route based on the first urgency level, and display the final movement route on the display device.

### CROSS-REFERENCE TO RELATED APPLICATION(S)

This application claims under 35 U.S.C. § 119 the benefit of Korean Patent Application No. 10-2020-0185587, filed on Dec. 29, 2020 in the Korean Intellectual Property Office, the entire contents of which are incorporated herein by reference.

### BACKGROUND

### (a) Technical Field

The disclosure relates to a vehicle for determining a movement route to a destination and a method of controlling the same.

### (b) Description of the Related Art

In recent years, drivers have increasingly utilized a navigation system to drive to their destinations. In particular, many drivers use a shortest distance route and a shortest time route to reach their destinations. However, in a conventional system, since a driver's tendency, current road conditions, weather, or the like is not taken into consideration, arriving at a destination may not be optimized using existing navigation systems.

As a result, research has focused on algorithms for setting recommended routes in a navigation system.

For example, in recommending a route, studies related to algorithms that recommend a route in consideration of not only a distance and a time, but also a user's preference, urgency levels, current traffic conditions, and weather, and the like have been actively conducted.

### SUMMARY

The disclosure provides a vehicle capable of determining a candidate location based on traffic information, determining a target location based on driving route information and a congestion level, and then determining a final movement route toward the target location and a method of controlling the same.

Additional aspects of the disclosure will be set forth in part in the description which follows and, in part, will be obvious from the description, or may be learned by practice of the disclosure.

In accordance with an aspect of the present disclosure, a vehicle includes a communication device configured to obtain traffic information from a server; an input device configured to receive departure information and destination information from a user; a display device; a storage configured to store driving record information; and a controller configured to obtain movement route information by searching for at least one movement route based on the departure information and the destination information, calculate a congestion level of the movement route based on the movement route information and the traffic information, if the congestion level is less than a predetermined reference value, determine a first urgency level in response to a destination based on at least one of the driving record information or the destination information, determine a final movement route based on the first urgency level, and display the final movement route on the display device.

The communication device may obtain place information from a user terminal, and the controller may determine the first urgency level based on the place information.

The controller may further include if the congestion level is greater than or equal to the predetermined reference value, obtain candidate destination information by determining at least one candidate destination located within a predetermined distance from a departure point based on the departure information and the destination information, obtain alternative destination information by determining an alternative destination based on the candidate destination information and the traffic information, search for at least one alternative movement route based on the departure information and the alternative destination information, determine a second urgency level in response to the alternative destination based on at least one of the driving record information or the destination information, and determine the final movement route based on the second urgency level.

The communication device may obtain location information of a personal mobility from the server, and the controller may determine the alternative destination based on the candidate destination information and the location information of the personal mobility.

The communication device may obtain parking space information of the candidate destination from the server, and the controller may determine the alternative destination based on the candidate destination information and the parking space information.

The controller, after determining the alternative destination, may identify the parking space information at a predetermined time interval, and change the alternative destination if an empty parking space in the parking space information does not exist and the second urgency level is less than a predetermined urgency level based on the parking space information and the second urgency level.

The controller, if an empty parking space in the parking space information does not exist based on the parking space information of the candidate destination, may identify whether another parking space exists within a predetermined range from the candidate destination, and if the another parking space exists, determine the candidate destination as the alternative destination.

The communication device may obtain weather information from the server, and the controller may determine the final movement route based on the movement route information and the weather information.

In accordance with another aspect of the present disclosure, a method of controlling a vehicle includes obtaining, by a communication device, traffic information from a server, receiving, by an input device, departure information and destination information from a user, storing, by a storage, driving record information, obtaining, by a controller, movement route information by searching for at least one movement route based on the departure information and the destination information, calculating, by the controller, a congestion level of the movement route based on the movement route information and the traffic information, if the congestion level is less than a predetermined reference value, determining, by the controller, a first urgency level in response to a destination based on at least one of the driving record information or the destination information; determining, by the controller, a final movement route based on the first urgency level, and controlling, by the controller, to display the final movement route on a display device.

The determining the first urgency level may include obtaining place information from a user terminal through the communication device, and determining the first urgency level based on the place information.

The determining the final movement route may include if the congestion level is greater than or equal to the predetermined reference value, obtaining candidate destination information by determining at least one candidate destination located within a predetermined distance from a departure point based on the departure information and the destination information, obtaining alternative destination information by determining an alternative destination based on the candidate destination information and the traffic information, searching for at least one alternative movement route based on the departure information and the alternative destination information, determining a second urgency level in response to the alternative destination based on at least one of the driving record information or the destination information, and determining the final movement route based on the second urgency level.

The determining the alternative destination may include obtaining location information of a personal mobility from the server through the communication device, and determining the alternative destination based on the candidate destination information and the location information of the personal mobility.

The determining the alternative destination may include obtaining parking space information of the candidate destination from the server through the communication device, and determining the alternative destination based on the candidate destination information and the parking space information.

The method may further include after determining the alternative destination, identifying, by the controller, the parking space information at a predetermined time interval, and changing the alternative destination if an empty parking space in the parking space information does not exist and the second urgency level is less than a predetermined urgency level based on the parking space information and the second urgency level.

The determining the alternative destination may include if an empty parking space in the parking space information does not exist based on the parking space information of the candidate destination, identifying whether another parking space exists within a predetermined range from the candidate destination, and if the another parking space exists, determining the candidate destination as the alternative destination.

The determining the final movement route may include obtaining weather information from the server through the communication device, and determining the final movement route based on the movement route information and the weather information.

### BRIEF DESCRIPTION OF THE DRAWINGS

These and/or other aspects of the disclosure will become apparent and more readily appreciated from the following description of the exemplary embodiments, taken in conjunction with the accompanying drawings, of which:

FIG. 1 is a view illustrating an operation of determining and displaying a final movement route according to an embodiment;

FIG. 2 is a diagram showing a control configuration of a vehicle according to an embodiment;

FIG. 3 is a view illustrating an operation of determining a final movement route by obtaining place information from a user terminal according to an embodiment;

FIG. 4 is a flowchart showing operations of determining a final movement route when a congestion level is greater than or equal to a predetermined reference according to an embodiment;

FIG. 5 is a view illustrating an operation of determining a final movement route in consideration of a personal mobility according to an embodiment;

FIG. 6 is a flowchart showing operations of determining an alternative destination in consideration of a parking space according to an embodiment;

FIG. 7 is a view illustrating an operation of determining a final movement route in consideration of a weather according to an embodiment;

FIG. 8 is a flowchart according to an embodiment.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. The terminology used herein is for the purpose of describing particular embodiments only and is not intended to be limiting of the disclosure.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Reference will now be made in detail to the embodiments of the present disclosure, examples of which are illustrated in the accompanying drawings, wherein like reference numerals refer to like elements throughout. This specification does not describe all elements of the disclosed embodiments and detailed descriptions of what is well known in the art or redundant descriptions on substantially the same configurations have been omitted.

Throughout the specification, when an element is referred to as being “connected to” another element, it may be directly or indirectly connected to the other element and the “indirectly connected to” includes being connected to the other element via a wireless communication network.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, embodiments of the present disclosure will be described in detail with reference to the accompanying drawings.

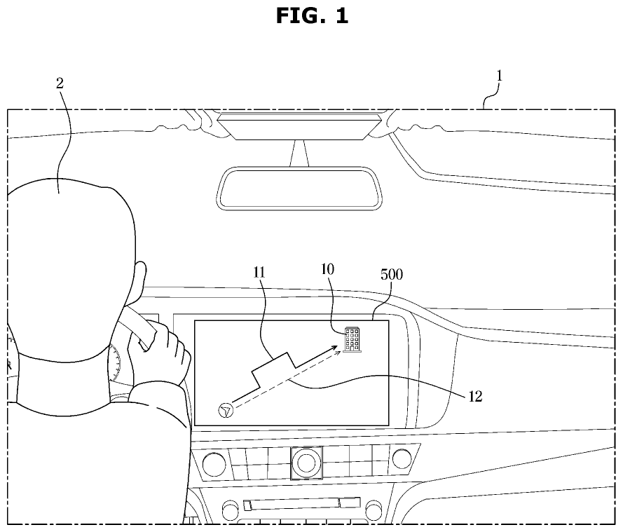

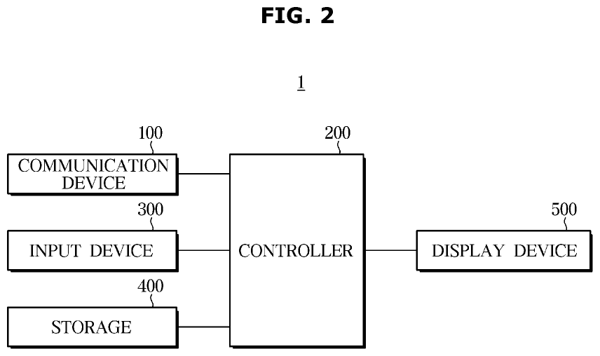

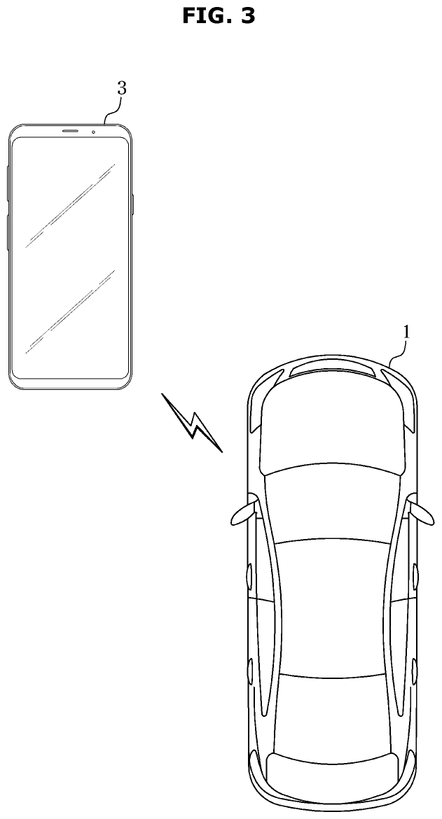

FIG. 1 is a view illustrating an operation of determining and displaying a final movement route 11 according to an embodiment. FIG. 2 is a diagram showing a control configuration of a vehicle according to an embodiment. FIG. 3 is a view illustrating an operation of determining the final movement route 11 by obtaining place information from a user terminal 3 according to an embodiment.

As shown in FIGS. 1-3, a vehicle 1 may include a communication device 100 for obtaining traffic information from a server, an input device 300 for inputting a departure point and a destination, a display device 500, a storage 400 for storing driving record information, and controller 200. The controller 200 may search for at least one movement route based on departure information and destination information, calculate a congestion level of the movement route based on movement route information and the traffic information, and when the congestion level is less than a predetermined reference value, determine a first urgency level in response to the destination based on the driving record information and the destination information, determine the final movement route 11 based on the first urgency level, and display the final movement route 11 on the display device 500.

Furthermore, the communication device 100 may obtain place information from the user terminal 3, and the controller 200 may determine the first urgency level based on the place information. The communication device 100 may obtain the traffic information from the server. The server may refer to a computer hardware on which a server program is executed, and also may refer to a computer program that provides services to other programs. The server may obtain navigation information, global positioning system (GPS) information, weather information, parking information, and the like to provide to the vehicle 1 through the communication device 100. The communication device 100 may include one or more components that enable communication with an external device, and may include, for example, at least one of a short-range communication module, a wired communication module, or a wireless communication module.

The short-range communication module may include various short-range communication modules that transmit and receive signals using the wireless communication network in a short-range, such as a Bluetooth module, an infrared communication module, a radio frequency identification (RFID) communication module, a wireless local access network (WLAN) communication module, a near field communication (NFC) module, a Zigbee communication module, or the like.

The wired communication module may include not only one of the various wired communication modules, such as a controller area network (CAN) communication module, a local area network (LAN) module, a wide area network (WAN) module, or a value added network (VAN) module, but also one of various cable communication modules, such as a universal serial bus (USB), a high definition multimedia interface (HDMI), a digital visual interface (DVI), recommended standard (RS) 232, a power cable, or a plain old telephone service (POTS), or the like.

The wireless communication module may include a wireless fidelity (WiFi) module, a wireless broadband (WiBro) module, and/or any wireless communication module for supporting various wireless communication schemes, such as a global system for a mobile communication (GSM) module, a code division multiple access (CDMA) module, a wideband code division multiple access (WCDMA) module, a universal mobile telecommunications system (UMTS), a time division multiple access (TDMA) module, a long-term evolution (LTE) module, or the like.

The wireless communication module may include a wireless communication interface including an antenna and a transmitter for transmitting a signal. Furthermore, the wireless communication module may further include a signal conversion module that modulates a digital control signal output from the controller 200 through the wireless communication interface into an analog radio signal according to control of the controller 200.

The wireless communication module may include a wireless communication interface including an antenna and receiver for receiving a signal. Furthermore, the wireless communication module may further include a signal conversion module for demodulating an analog wireless signal received through the wireless communication interface into a digital control signal.

The input device 300 may refer to a device that receives a user's input. The input device 300 may include a user interface and may use audio, video, and navigation (AVN). The departure and the destination may be input through the input device 300. The departure may include a location on which the user is currently located. The display device 500 may refer to a device for guiding a route. The display device 500 may include the AVN, as well as various alarm devices. The storage 400 may store the driving record information. The storage 400 may be implemented as at least one of a non-volatile memory device such as a cache, a read only memory (ROM), a programmable ROM (PROM), an erasable programmable ROM (EPROM), an electrically erasable programmable ROM (EEPROM), and flash memory or a volatile memory device such as a random access memory (RAM) or a storage medium such as a hard disk drive (HDD), a compact disc ROM, but is not limited thereto. The storage 400 may be a memory implemented as a chip separate from the processor described above with respect to the controller 200, or may be implemented as a single chip with the processor. The driving record information may refer to information recorded by the user while driving. Particularly, the driving record information may include information on a destination and an arrival, and driving route information that the user has driven so far. The controller 200 may search for at least one movement route based on the departure information and the destination information. At this time, searching for the movement route may include a shortest time route and a shortest distance route, and in addition, the movement route may be searched in consideration of whether an accident has occurred in the movement route or whether the movement route is not congested. Thereafter, the controller 200 may calculate a congestion level of the movement route based on the movement route information and the traffic information. The traffic information may refer to information including a variety of situations occurring on a road. For example, the traffic information may refer to information for determining how congested the road is and what the current situation is. The congestion level may refer to a quantification of how congested the road is on the movement route. If the congestion level is less than a predetermined reference value, the controller 200 may determine the first urgency level in response to a destination 10 based on the driving record information and the destination information. The predetermined reference value is a reference value for the congestion level, and if the congestion level is greater than or equal to the predetermined reference value, it may indicate that the road is heavily congested. The predetermined reference value may be set to different values. The first urgency level may refer to an urgency level when heading to a destination. For example, if a nearby person is in a dangerous emergency state, a hospital may be determined as the destination 10, and the hospital may be determined to be in an urgent state based on the driving record information so far, and also the destination 10 itself as a hospital is measured to the urgency level. The first urgency level may refer to a numerical value of a degree of urgency corresponding to the destination 10. When determining the final movement route 11, based on the first urgency level, if urgent, arriving in the shortest time may be prioritized, and if simply for a drive, a leisurely route may be selected even if it takes a little longer. The first urgency level may be predetermined depending on the destination 10 or may be determined based on the destination 10 or the driving record information. Thereafter, when the controller 200 determines the final movement route 11, the final movement route 11 may be displayed on the display device 500. In this case, although not the final movement route 11, a movement route 12 considered in a process of determining the final movement route may also be displayed on the display device 500. The communication device 100 may obtain the place information from a user terminal 3. The place information is a place stored in the user terminal 3, for example, may refer to information that the user sets such as a specific location as a home, or may refer to information stored in a specific location such as a company, a hospital, a restaurant, or the like.

The controller 200 is a processor that controls overall operations of the vehicle 1, and may be a processor of an electronic control unit (ECU) that controls overall operations of power system. Furthermore, the controller 200 may control operations of various modules and devices installed in the vehicle 1. According to an embodiment, the controller 200 may generate a control signal for controlling various modules, devices, etc. installed in the vehicle 1 to control the operation of each component.

Furthermore, the controller 200 may include a memory in which a program for performing operations to be described above and below and a variety of data related thereto is stored, and a processor for executing the program stored in the memory. Furthermore, the controller 200 may be integrated in a system on chip (SOC) embedded in the vehicle 1 and may be operated by a processor. However, since the SOC embedded in the vehicle 1 may be plural, it is not limited to being integrated into one SOC.

The controller 200 may be implemented through at least one type of storage medium, for example, a flash memory type, a hard disk type, a multimedia card micro type, a card type memory such as a secure digital (SD) or an extreme digital (XD) memory, etc., a RAM, a static random access memory (SDRAM), a ROM, a EEPROM, a PROM, a magnetic memory, a magnetic disk, and an optical disk, or the like. However, the disclosure is not limited thereto, and may be implemented in any other form known in the art.

At least one component may be added or deleted according to performance of the components of the vehicle 1 shown in FIG. 2. Furthermore, it will be readily understood by those of ordinary skill in the art that the mutual positions of the components may be changed corresponding to performance or structure of the system.

Meanwhile, each component shown in FIG. 2 may refer to software and/or hardware components, such as a field programmable gate array (FPGA) and an application specific integrated circuit (ASIC).

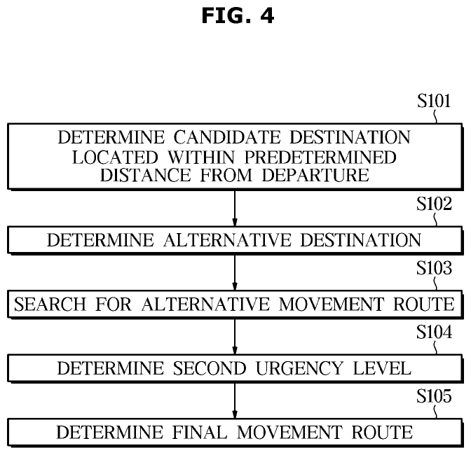

FIG. 4 is a flowchart showing operations of determining a final movement route when a congestion level is greater than or equal to a predetermined reference according to an embodiment.

The controller 200 may determine at least one candidate destination located within a predetermined distance from the departure based on the departure information and the destination information (S101), determine an alternative destination based on candidate destination information and the traffic information (S102), search for at least one alternative movement route based on the departure information and the alternative destination information (S103), determine a second urgency level in response to the alternative destination based on the driving record information and the destination information (S104), and determine the final movement route based on the second urgency level (S105). If the congestion level is greater than or equal to the predetermined reference value, it may indicate that vehicles are congested on the movement route. In such a case, another place may be searched even if it is not the destination. In this case, the at least one candidate destination located within the predetermined distance from the departure may be determined based on the departure information and the destination information. Herein, the predetermined distance may refer to a distance adjacent to the departure, and may be predetermined to different values. The candidate destination may refer to another suitable arrival place that may replace the destination by reflecting a user's intention. The controller 200 may determine the alternative destination based on the candidate destination information and the traffic information. If the candidate destination is a plural, a less congested place may be determined as the alternative destination based on the traffic information. If the candidate destination is one, the alternative destination may be determined based on the traffic information. The controller 200 may search for the at least one alternative movement route based on the departure information and the alternative destination information. The alternative movement route may refer to a route that may move to the alternative destination, and likewise may be determined based on the shortest distance, the shortest time, and other various conditions. The controller 200 may determine the second urgency level based on the driving record information and the destination information. In this case, the controller 200 may determine the second urgency level by obtaining the place information from the user terminal 3. The second urgency level may refer to a numerical value of a degree of urgency corresponding the alternative destination. The controller 200 may determine the final movement route based on the second urgency level.

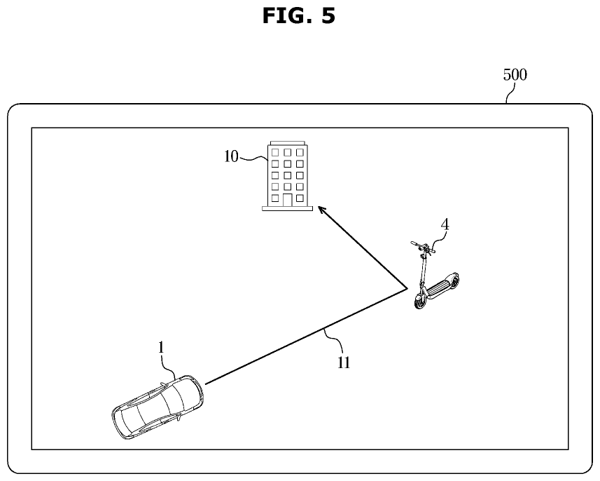

FIG. 5 is a view illustrating an operation of determining the final movement route 11 in consideration of a personal mobility 4 according to an embodiment. Referring to FIG. 5, the communication device may obtain location information of the personal mobility 4. The personal mobility 4 is an electricity-driven single person transportation device and may include a power wheel, an electric kickboard, an electric bicycle, an ultra-compact electric vehicle, and the like. In this case, the communication device may obtain not only the location information of the personal mobility 4 but also a distance and a time when moving by foot. In other words, the communication device may obtain information regarding not only the personal mobility 4 but also in the case of moving to the destination 10 by walking. The controller may determine the alternative destination information based on the candidate destination information and the location information of the personal mobility 4. If the personal mobility 4 is close to the alternative destination, the controller may also include a route in which the user moves to the vehicle and then transfers to the personal mobility 4 in the middle to arrive at the alternative destination. In other words, when determining the alternative destination, not only the personal mobility 4 but also the route taken with the vehicle to the vicinity of the alternative destination and then walking may be considered.

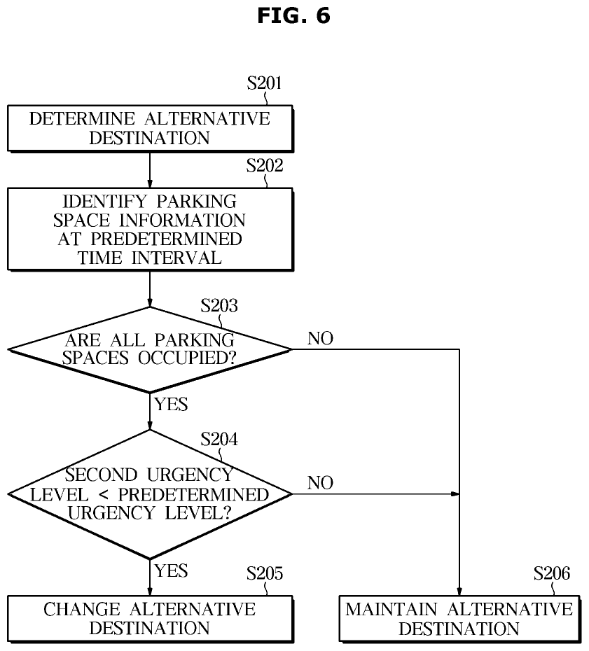

FIG. 6 is a flowchart showing operations of determining an alternative destination in consideration of a parking space according to an embodiment. The communication device may obtain parking space information of the candidate destination. The communication device may obtain the parking space information regarding the destination, the candidate destination, and the alternative destination. The controller may determine the alternative destination based on the candidate destination information and the parking space information (S201). The controller may also determine the destination based on the parking space information of the destination. After determining the alternative destination, the controller may identify the parking space information at a predetermined time interval (S202), and based on the identified parking space information and the second urgency level if an empty parking space among parking spaces (of the parking space information) does not exist and the second urgency level is less than a predetermined urgency level, the alternative destination may be changed. The fact that the empty parking space in the parking spaces does not exist may indicate that the parking spaces are all occupied, and depending on a user's setting, space information corresponding to a predetermined space, for example, a situation in which the parking space is empty for two or three digits, may be preset. In an embodiment, the controller 200 may determine whether all the parking spaces are occupied (S203). Identifying the parking space information at the predetermined time interval considers a case in which all vehicles are occupied in a parking lot after the alternative destination is determined in consideration of the parking space information. In such a case, since a parking may take time, a new alternative destination may be searched. Before searching for the new alternative destination, the second urgency level may be first considered (S204). If the urgency level is great, maintaining the existed alternative destination is necessary even if the empty parking space does not exist (S206). In this case, if immediate parking due to the second urgency level is needed, even if the second urgency level is greater than or equal to the predetermined urgency level, the alternative destination may be searched for and changed (S205). In other words, whether the second urgency is greater than or equal to the predetermined urgency level or whether the alternate destination is changed if the second urgency level is less than the predetermined urgency level may vary depending on circumstances. The controller may identify whether another parking space exists within a predetermined range from the candidate destination if an empty parking space in the parking space information does not exist based on the parking space information of the candidate destination, and if another parking space exists determine the candidate destination as the alternative destination. The (another) parking space may be identified by obtaining the parking space information from the server. At this time, the server may obtain parking information data from each of the parking lots, and the controller may obtain the parking information data obtained from the server through the communication device. Although not shown in the drawings, the controller 200 may determine whether an accident has occurred on a route to the alternative destination at a predetermined time interval. It is determined whether an accident has occurred at the predetermined time interval and if an accident has occurred, likewise, another alternative destination may be changed in consideration of the second urgency level. This is because, in the event of an accident, a time that takes to reach an alternative destination may increase to a certain extent. Likewise, in consideration of the second urgency level, if the second urgency level is greater than or equal to the predetermined reference value or according to a setting in the case of the second urgency level being less than the predetermined reference value, the alternative destination may be changed or maintained.

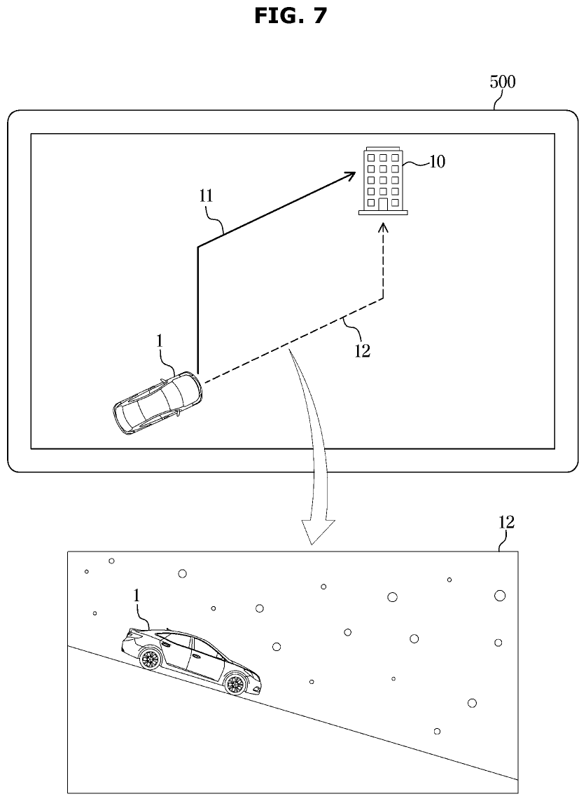

FIG. 7 is a view illustrating an operation of determining a final movement route in consideration of a weather according to an embodiment. Referring to FIG. 7, the communication device 100 may obtain weather information, and the controller 200 may determine the final movement route 11 based on the movement route information and the weather information. In order to determine the suitable final movement route 11, factors suh as the season, climate, weather, etc. may be considered. For example, in the case of a snowy day, a downhill road may not be a good route because it may be dangerous for the vehicle 1 to travel. Accordingly, the movement route 12 including the downhill road may not be selected as the final movement route 11. However, the movement route 12 including the downhill road may also be displayed on the display device 500 for a user 2 to select (see also FIG. 1).

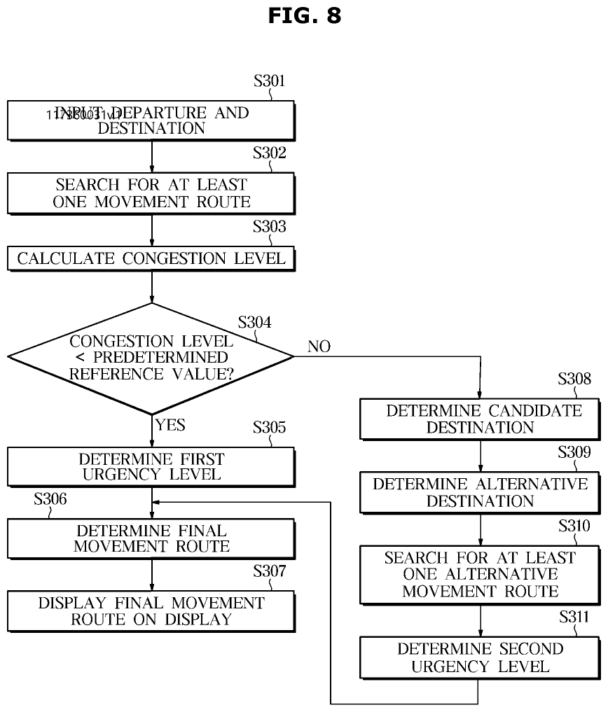

FIG. 8 is a flowchart according to an embodiment.

Referring to FIG. 8, the departure and the destination may be input through the departure and destination information input by the user (S301). Thereafter, at least one movement route may be searched (S302). Thereafter, the congestion level of the movement route is calculated (S303), and the congestion level and the predetermined reference value may be compared (S304). In comparison, if the congestion level is less than the predetermined reference value, the first urgency level may be determined (S305), and the final movement route may be determined based on the first urgency level (S306). The specific method is as described above. Thereafter, the controller may display the final movement route on the display device (S307). If the congestion level is greater than or equal to the predetermined reference value, the candidate destination may be determined (S308). Thereafter, then alternative destination may be determined among the candidate destinations (S309). Thereafter, the at least one alternative movement route that is a route to the alternative destination may be searched (S310), and the second urgency level may be determined (S311). The final movement route may be determined based on the second urgency level and the alternative movement route (S306), and the final movement route may be displayed on the display device (S307).

Meanwhile, the disclosed embodiments may be implemented in the form of a recording medium storing instructions executable by a computer. Instructions may be stored in the form of program code, and when executed by a processor, may generate program modules to perform operations of the disclosed embodiments. The recording medium may be implemented as a computer-readable recording medium.

As is apparent from the above, the embodiments of the disclosure can determine the candidate destination based on the traffic information, determine a target location based on the driving route information and the congestion level and then the final movement route heading to the target location, and display the final movement route on the display device, thereby improving user convenience.

In addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable recording medium includes all kinds of recording media in which instructions which can be decoded by a computer are stored, for example, a read only memory (ROM), a random access memory (RAM), a magnetic tape, a magnetic disk, a flash memory, an optical data storage device, and the like.

Logical blocks, modules or units described in connection with embodiments disclosed herein can be implemented or performed by a computing device having at least one processor, at least one memory and at least one communication interface. The elements of a method, process, or algorithm described in connection with embodiments disclosed herein can be embodied directly in hardware, in a software module executed by at least one processor, or in a combination of the two. Computer-executable instructions for implementing a method, process, or algorithm described in connection with embodiments disclosed herein can be stored in a non-transitory computer readable storage medium.

The embodiments of the present disclosure have thus far been described with reference to accompanying drawings. It will be obvious to those of ordinary skill in the art that the present disclosure may be practiced in other forms than the exemplary embodiments as described above without changing the technical idea or essential features of the present disclosure. The above exemplary embodiments are only by way of example, and should not be interpreted in a limited sense.

What is claimed is:

1. A vehicle, comprising:
a communication device configured to obtain traffic information from a server;
an input device configured to receive departure information and destination information from a user;
a display device;
a storage configured to store driving record information; and
a controller configured to:
obtain movement route information by searching for at least one movement route based on the departure information and the destination information,
calculate a congestion level of the movement route based on the movement route information and the traffic information,
if the congestion level is less than a predetermined reference value, determine a first urgency level in response to a destination based on at least one of the driving record information or the destination information,
determine a final movement route based on the first urgency level, and
display the final movement route on the display device.

2. The vehicle of claim 1, wherein:
the communication device obtains place information from a user terminal from the server, and
the controller determines the first urgency level based on the place information.

3. The vehicle of claim 1, wherein the controller is further configured to:
if the congestion level is greater than or equal to the predetermined reference value, obtain candidate destination information by determining at least one candidate destination located within a predetermined distance from a departure point based on the departure information and the destination information,
obtain alternative destination information by determining an alternative destination based on the candidate destination information and the traffic information,
search for at least one alternative movement route based on the departure information and the alternative destination information,
determine a second urgency level in response to the alternative destination based on at least one of the driving record information or the destination information, and
determine the final movement route based on the second urgency level.

4. The vehicle of claim 3, wherein:
the communication device obtains location information of a personal mobility from the server, and
the controller determines the alternative destination based on the candidate destination information and the location information of the personal mobility.

5. The vehicle of claim 3, wherein:
the communication device obtains parking space information of the candidate destination from the server, and
the controller determines the alternative destination based on the candidate destination information and the parking space information.

6. The vehicle of claim 5, wherein the controller, after determining the alternative destination, identifies the parking space information at a predetermined time interval, and changes the alternative destination if an empty parking space in the parking space information does not exist and the second urgency level is less than a predetermined urgency level based on the parking space information and the second urgency level.

7. The vehicle of claim 3, wherein the controller, if an empty parking space in the parking space information does not exist based on the parking space information of the candidate destination identifies whether another parking space exists within a predetermined range from the candidate destination, and if the another parking space exists determines the candidate destination as the alternative destination.

8. The vehicle of claim 1, wherein:
the communication device obtains weather information from the server, and
the controller determines the final movement route based on the movement route information and the weather information.

9. A method of controlling a vehicle, comprising:
obtaining, by a communication device, traffic information from a server,
receiving, by an input device, departure information and destination information from a user,
storing, by a storage, driving record information,
obtaining, by a controller, movement route information by searching for at least one movement route based on the departure information and the destination information,
calculating, by the controller, a congestion level of the movement route based on the movement route information and the traffic information,
if the congestion level is less than a predetermined reference value, determining, by the controller, a first urgency level in response to a destination based on at least one of the driving record information or the destination information;
determining, by the controller, a final movement route based on the first urgency level, and
controlling, by the controller, to display the final movement route on a display device.

10. The method of claim 9, wherein determining the first urgency level comprises:
obtaining place information from a user terminal through the communication device, and
determining the first urgency level based on the place information.

11. The method of claim 9, wherein determining the final movement route comprises:
if the congestion level is greater than or equal to the predetermined reference value, obtaining candidate destination information by determining at least one candidate destination located within a predetermined distance from a departure point based on the departure information and the destination information,
obtaining alternative destination information by determining an alternative destination based on the candidate destination information and the traffic information,
searching for at least one alternative movement route based on the departure information and the alternative destination information,
determining a second urgency level in response to the alternative destination based on at least one of the driving record information or the destination information, and
determining the final movement route based on the second urgency level.

12. The method of claim 11, wherein determining the alternative destination comprises:
obtaining location information of a personal mobility from the server through the communication device, and
determining the alternative destination based on the candidate destination information and the location information of the personal mobility.

13. The method of claim 11, wherein determining the alternative destination comprises:
obtaining parking space information of the candidate destination from the server through the communication device, and
determining the alternative destination based on the candidate destination information and the parking space information.

14. The method of claim 13, further comprising:
after determining the alternative destination, identifying, by the controller, the parking space information at a predetermined time interval, and changing the alternative destination if an empty parking space in the parking space information does not exist and the second urgency level is less than a predetermined urgency level based on the parking space information and the second urgency level.

15. The method of claim 11, wherein determining the alternative destination comprises:
if an empty parking space in the parking space information does not exist based on the parking space information of the candidate destination, identifying whether another parking space exists within a predetermined range from the candidate destination, and
if the another parking space exists, determining the candidate destination as the alternative destination.

16. The method of claim 9, wherein determining the final movement route comprises:
obtaining weather information from the server through the communication device, and
determining the final movement route based on the movement route information and the weather information.
